(19) United States
(12) Patent Application Publication
(10) Pub. No.: US 2024/0216979 A1
(43) Pub. Date: Jul. 4, 2024

(54) RECHARGEABLE BATTERY AND DEVICE FOR FORMING POUCH OF THE SAME

(71) Applicant: SAMSUNG SDI CO., LTD., Yongin-si (KR)

(72) Inventor: Jinhwan KIM, Yongin-si (KR)

(21) Appl. No.: 18/232,455

(22) Filed: Aug. 10, 2023

(30) Foreign Application Priority Data
Dec. 28, 2022 (KR) 10-2022-0187881

(51) Int. Cl. B21D 28/26; H01M 50/105; H01M 50/129

(52) U.S. Cl. CPC B21D 28/26; H01M 50/105; H01M 50/129

(57) ABSTRACT

A rechargeable battery includes a pouch that includes an outer flange disposed at an outer periphery thereof and a forming portion formed by forming with respect to a reverse forming portion; and a stacking type of electrode assembly included in the pouch. The forming portion includes a side wall corner portion connected to the outer flange and a bottom connected to the side wall corner portion, and the bottom includes a round portion connected to the side wall corner portion and a main bottom formed by absorbing the reverse forming portion formed during reverse forming of the pouch.

### CROSS-REFERENCE TO RELATED APPLICATION

This application claims priority to and the benefit of Korean Patent Application No. 10-2022-0187881, filed in the Korean Intellectual Property Office on Dec. 28, 2022, the entire contents of which are incorporated herein by reference.

### BACKGROUND

### 1. Field

The present disclosure relates to a rechargeable battery and a device for forming a pouch of the rechargeable battery. More specifically, the present disclosure relates to a rechargeable battery and a device for forming a pouch of the rechargeable battery that stably secures a thickness of a side wall corner portion of the pouch and a thickness of a bottom of the pouch connected to the side wall corner portion.

### 2. Description of the Related Art

A rechargeable battery is a battery that repeatedly performs charging and discharging, unlike a primary battery. A small-capacity rechargeable battery may be used in a portable small electronic device, e.g., a mobile phone, a laptop computer, or a camcorder, and a large-capacity rechargeable battery may be used as a power source for driving motors of, e.g., a hybrid vehicle and an electric vehicle.

For example, the rechargeable battery may include an electrode assembly for charging and discharging, a pouch for accommodating the electrode assembly, and an electrode terminal electrically connected to the electrode assembly to draw the electrode assembly out to the outside of the pouch. For example, the electrode assembly may be a winding type, in which a negative electrode plate and a positive electrode plate are wound on both sides of a separator interposed therebetween, and a stacking type, in which a negative electrode plate and a positive electrode plate are stacked on both sides of a separator interposed therebetween.

### SUMMARY

A device for forming a pouch of a rechargeable battery according to an embodiment of the present disclosure may include a die that supports a first surface of a substrate of the pouch for the rechargeable battery and forms a first opening so that the substrate of the pouch is formed after the substrate of the pouch is reversely formed; a stripper that holds a second surface of the substrate of the pouch supported by the die and forms a second opening larger than the first opening; a reverse punch that ascends through the first opening at a side of the first surface of the substrate of the pouch to reversely form the substrate of the pouch and performs primary stretching for a side wall corner portion of the pouch and a portion corresponding to a bottom connected to the side wall corner portion; and a punch that descends through the second opening at a side of the second surface of the substrate of the pouch from an opposite side of the reverse punch to form the substrate of the pouch and supplements a thickness of the side wall corner portion of the pouch and a thickness of the bottom connected to the side wall corner portion when secondary stretching is performed by absorbing the primary stretching.

In a diagonal cross-section of the substrate of the pouch corresponding to the side wall corner portion of the pouch and the bottom connected to the side wall corner portion, a length of the reverse punch may be 70 to 90% of a length of the punch.

A depth of reverse forming of the substrate of the pouch may be 3.5 mm to 5.5 mm.

The reverse punch may primarily form a reverse forming portion of the substrate of the pouch having a reverse direction depth within the second opening.

The punch may secondarily form a forming portion of the substrate of the pouch having a forward direction depth within the first opening while absorbing the reverse forming portion.

The reverse punch may form a reverse forming portion at the side wall corner portion of the pouch and the portion corresponding to the bottom connected to the side wall corner portion in the substrate of the pouch, and the reverse forming portion may include an outer flange region provided at an outer periphery of the substrate of the pouch, a central region minimally stretched from a center of the substrate of the pouch, an outer bending region bent and stretched due to reverse forming of the substrate of the pouch in the outer flange region, and a first reverse stretching region, a second reverse stretching region, and a third reverse stretching region sequentially stretched in a reverse direction between the outer bending region and the central region.

The reverse punch may reversely form a reverse direction depth of the reverse forming portion to 3.5 mm to 5.5 mm with respect to the outer flange region as a reference plane, and may stretch the first reverse stretching region, the second reverse stretching region, and the third reverse stretching region by 4 μm to 5 μm.

The reverse punch may maximally stretch the first reverse stretching region, the second reverse stretching region, and the third reverse stretching region at the reverse forming portion.

The reverse punch may form the reverse forming portion, and a thickness of a section between the outer bending region and the first reverse stretching region may decrease at a first change rate, a thickness of a section between the first reverse stretching region and the second reverse stretching region may decrease at a second change rate smaller than the first change rate, a thickness of a section between the second reverse stretching region and the third reverse stretching region may increase inversely to the second change rate, and a thickness of a section between the third reverse stretching region and the central region may increase at a third change rate.

A rechargeable battery according to an embodiment of the present disclosure includes: a pouch that includes an outer flange disposed at an outer periphery thereof and a forming portion formed by forming with respect to a reverse forming portion; and a stacking type of electrode assembly included in the pouch, and the forming portion includes a side wall corner portion connected to the outer flange and a bottom connected to the side wall corner portion, while the bottom includes a round portion connected to the side wall corner portion and a main bottom formed by absorbing the reverse forming portion formed during reverse forming of the pouch.

In a diagonal direction of the main bottom, a forming length of the forming portion formed during the forming may be longer than a reverse forming length of the reverse forming portion.

The reverse forming length may be 70 to 90% of the forming length.

The reverse forming portion may include an outer flange region, an outer bending region, a first reverse stretching region, a second reverse stretching region, a third reverse stretching region, and a central region sequentially formed from outer peripheries of the side wall corner portion of the pouch and a portion corresponding to the bottom connected to the side wall corner portion in a substrate of the pouch to centers of the side wall corner portion of the pouch and the portion corresponding to the bottom connected to the side wall corner portion, and the side wall corner portion of the forming portion may be formed of a portion excluding the outer flange at the outer flange region.

The round portion may be formed by stretching the outer bending region to be connected to the side wall corner portion, and the main bottom may be formed by absorbing the first reverse stretching region, the second reverse stretching region, the third reverse stretching region, and the central region.

A height of the side wall corner portion may be 3.5 mm to 5.5 mm, and a thickness of the pouch may be 76 μm to 85 μm.

A height of the side wall corner portion may be 3.5 mm to 4.5 mm, and when a thickness of the pouch is 76 μm, a thickness of the round portion may be 15.82 μm to 16.92 μm.

A height of the side wall corner portion may be 4.0 mm to 5.0 mm, and when a thickness of the pouch is 85 μm, a thickness of the round portion may be 16.13 μm to 18.01 μm.

A thickness of the main bottom may gradually increase as the main bottom goes from the round portion to a center of the bottom.

When a thickness of the pouch is 85 μm and a thickness of the side wall corner portion is 21.04 μm to 21.54 μm, a thickness of the round portion may be 20.48 μm to 20.79 μm.

A thickness of the main bottom may be 21.43 μm to 27.62 μm.

### BRIEF DESCRIPTION OF THE DRAWINGS

Features will become apparent to those of skill in the art by describing in detail exemplary embodiments with reference to the attached drawings, in which:

FIG. 1 is a configuration diagram of a forming preparation step (or a shaping preparation step) of a device for forming a pouch of a rechargeable battery according to an embodiment of the present disclosure.

FIG. 2 is an operation state diagram of a stripper lowering step of the device for forming the pouch of the rechargeable battery of FIG. 1.

FIG. 3 is an operational state diagram of a reverse forming step following FIG. 2.

FIG. 4 is an operation state diagram of a forming step following FIG. 3.

FIG. 5 is a configuration diagram showing a relative size of a reverse punch length with respect to a punch length in the configuration diagram of FIG. 1.

FIG. 6 is a planar image of the pouch reversely formed with a reverse punch having a length relationship of FIG. 5.

FIG. 7 is a cross-sectional view of a reverse forming state taken along a line VII-VII of FIG. 6.

FIG. 8 is a cross-sectional view of a forming state after reverse forming of FIG. 7.

FIG. 9 is a perspective view of a rechargeable battery manufactured as a pouch through reverse forming and forming of FIG. 8.

FIG. 10 is an exploded perspective view of FIG. 9.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

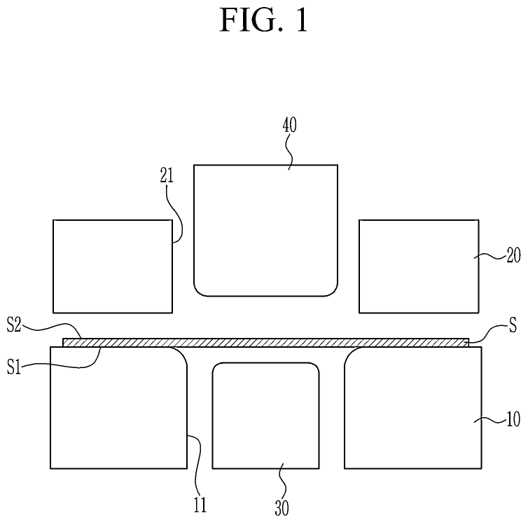

FIG. 1 is a schematic configuration diagram of a forming preparation step (or a shaping preparation step) of a device for forming a pouch of a rechargeable battery according to an embodiment of the present disclosure. Referring to FIG. 1, the device for forming the pouch of the rechargeable battery according to the embodiment may include a die 10, a stripper 20, a reverse punch 30, and a punch 40.

As illustrated in FIG. 1, the die 10 may include a first opening 11 therein. For example, as illustrated in FIG. 1, the first opening 11 may be defined, e.g., formed, between at least two portions of the die 10 that are, e.g., horizontally, spaced apart from each other, e.g., upper corners of the two portions of the die 10 that face each other and the first opening 11 may be rounded. In another example, the first opening 11 may be completely surrounded by a continuous inner sidewall of the die 10.

The die 10 may support a first surface S1 (i.e., first face) of a pouch substrate S (i.e., a basic material or a material) of the pouch for the rechargeable battery, and may form the first opening 11 so that the pouch is formed (or shaped) by reversely forming the pouch substrate S and then forming (or forwardly forming) the pouch. For example, as illustrated in FIG. 1, the pouch substrate S may extend continuously, e.g., and directly, on the die 10, while completely overlapping, e.g., covering, the first opening 11.

As illustrated in FIG. 1, the stripper 20 may face the die 10, e.g., the stripper 20 and the die 10 may vertically overlap each other, and may include a second opening 21. For example, the second opening 21 of the stripper 20 may be defined, e.g., formed, between at least two portions of the stripper 20 that are, e.g., horizontally, spaced apart from each other. In another example, the second opening 21 may be completely surrounded by a continuous inner sidewall of the stripper 20. For example, as further illustrated in FIG. 1, the first and second openings 11 and 21 may overlap each other and may be concentric with each other. For example, the second opening 21 may be larger, e.g., may have a larger width in the horizontal direction, than the first opening 11.

As further illustrated in FIG. 1, the reverse punch 30 may be positioned in the first opening 11, e.g., spaced apart from the inner sidewall of the die 10, and the punch 40 may be positioned in the second opening 21, e.g., spaced apart from the inner sidewall of the stripper 20. For example, as illustrated in FIG. 1, the reverse punch 30 and the punch 40 may be positioned to face, e.g., vertically overlap, each other. For example, the reverse punch 30 may be configured to move vertically through the first opening 11 toward the second opening 21, and the punch 40 may be configured to move vertically in a direction opposite to that of the reverse punch 30, e.g., through the second opening 21 toward the first opening 11, e.g., the reverse punch 30 and the punch 40 may be configured to move sequentially. For example, as illustrated in FIG. 0.1, the punch 40 may be vertically spaced apart from the reverse punch 30.

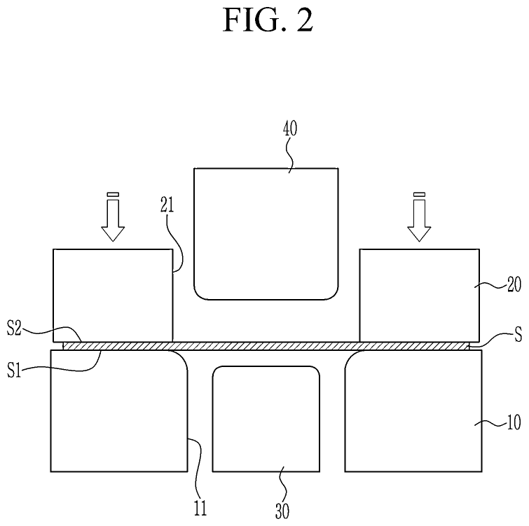

FIG. 2 is an operation state diagram of the stripper 20 lowering step of the device for forming the pouch of the rechargeable battery of FIG. 1. Referring to FIG. 2, the stripper 20 may be lowered to contact, e.g., hold, a second surface S2 (i.e., a second face) of the pouch substrate S supported by the die 10, and may form the second opening 21 that is larger than the first opening 11 and has concentricity. For example, as illustrated in FIG. 2, the pouch substrate S may be directly held between the die 10 and the stripper 20. For example, as further illustrated in FIG. 2, the pouch substrate S may extend continuously, e.g., and directly, on the stripper 20, while vertically completely overlapping the second opening 21. For example, a lower surface of the pouch substrate S is referred to as the first surface S1, and an upper surface of the pouch substrate S is referred to as the second surface S2.

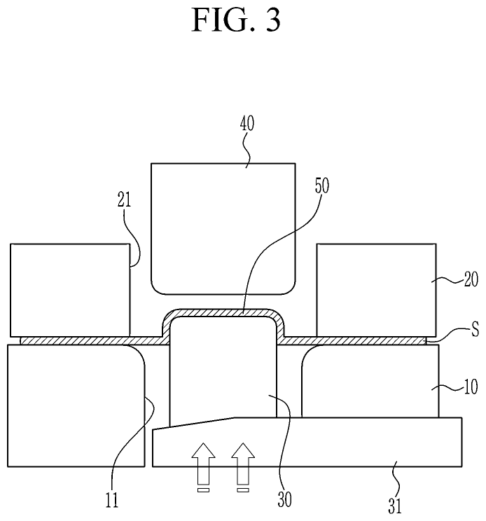

FIG. 3 is an operational state diagram of a reverse forming step following FIG. 2. Referring to FIG. 3, the reverse punch 30 ascends (or lifts) through the first opening 11 at a side of the first surface S1 of the pouch substrate S to reversely form the pouch substrate S, e.g., the reverse punch 30 may move through the first opening 11 into an empty space in the second opening 21 (e.g., without reaching or contacting the punch 40) while pushing a portion of the pouch substrate S into the empty space of the second opening 21. That is, a reverse forming portion 50 may be formed at the pouch substrate S below the punch 40 and within the second opening 21 of the stripper 20, e.g., a portion of the pouch substrate S pushed into the second opening 21 by the reverse punch 30 may be conformal on the reverse punch 30 and define the reverse forming portion 50 in the second opening 21. As an example, the reverse punch 30 may be lifted and lowered by a cylinder 31.

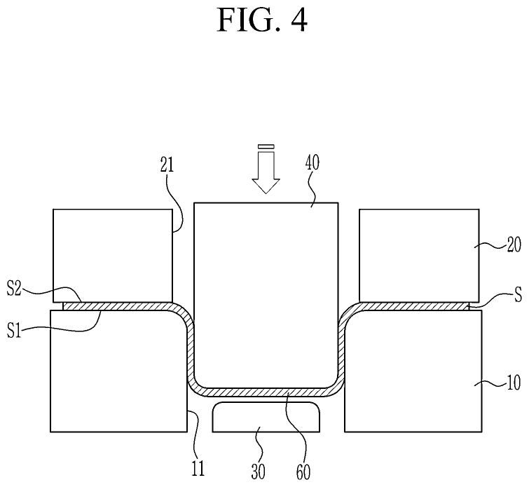

FIG. 4 is an operation state diagram of a forming step following FIG. 3. For example, referring to FIG. 4, after the reverse punch 30 is lifted and lowered back by the cylinder 31 (and while the formed reverse forming portion 50 remains in the empty space in the second opening 21), the punch 40 may descend through the second opening 21 at a side of the second surface S2 of the pouch substrate S from an opposite side of the reverse punch 30 into the first opening 11. For example, as illustrated in FIG. 4, the punch 40 may descend through the second opening 21 into an empty space in the first opening 11 while pushing the reverse forming portion 50 into the first opening 11 to form a forming portion 60 in the first opening 11. The forming of the forming portion 60 absorbs the reverse forming portion 50, e.g., the punch 40 may push through the reverse forming portion 50 to form the forming portion 60 of the pouch substrate S. That is, the forming portion 60 is formed at the pouch substrate S above the reverse punch 30 and within the first opening 11 of the die 10.

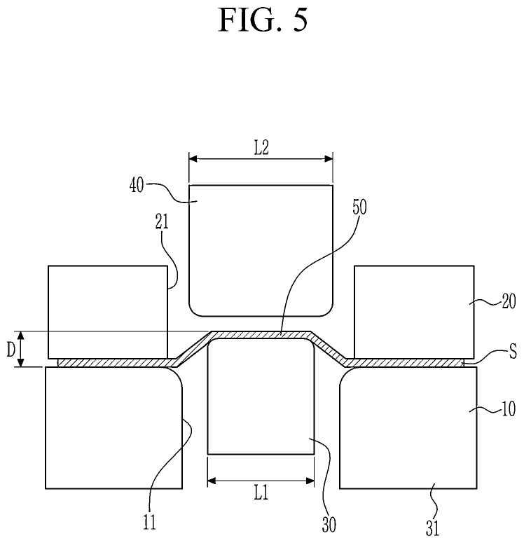

FIG. 5 is a configuration diagram showing a relative size of a reverse punch length with respect to a punch length in the configuration diagram of FIG. 1. Referring to FIGS. 1 to 5, in a diagonal cross-section of the pouch substrate S, a length L1 of the reverse punch 30 forming the reverse forming portion 50 is 70% to 90% of a length L2 of the punch 40 (i.e., L1=(0.7 to 0.9)*L2). The length L1 is the ‘diagonal length’ of the reverse punch 30, and the length L2 is the ‘diagonal length’ of the forward punch 40.

When the length L1 of the reverse punch 30 is less than 70% of the length L2 of the punch 40, a distance between the reverse punch 30 and an inner surface of the second opening 21 of the stripper 20 is too large, so that an effect of reverse forming is lowered. When the length L1 of the reverse punch 30 exceeds 90% of the length L2 of the punch 40, the distance between the reverse punch 30 and the inner surface of the second opening 21 of the stripper 20 may be too small, so a distance between the reverse punch and a stretching object for the reverse forming may be too short, thereby increasing a potential for damaging the pouch substrate S during the reverse forming.

A depth D of the reverse forming formed by the reverse forming portion 50, i.e., a vertical distance that the reverse punch 30 protrudes into the second opening 21 plus a thickness of the pouch substrate S, may be about 3.5 mm to 5.5 mm. In addition, when the depth D of the reverse forming is less than 3.5 mm, the effect of the reverse forming is reduced. When the depth D of the reverse forming is greater than 5.5 mm, the pouch substrate S may be damaged due to excessive reverse forming.

For example, a thickness of the pouch substrate S is about 76 μm to 85 μm, and a height of a side wall of the pouch is 3.5 mm to 5.5 mm. The depth of the reverse forming may be changed according to the height of the sidewall of the pouch by the forming and the thickness of the pouch substrate S.

As described above, the reverse punch 30 may primarily form (or shape) the reverse forming portion 50 of the pouch substrate S having a reverse direction depth within the second opening 21. The reverse direction depth means the depth D of the reverse forming.

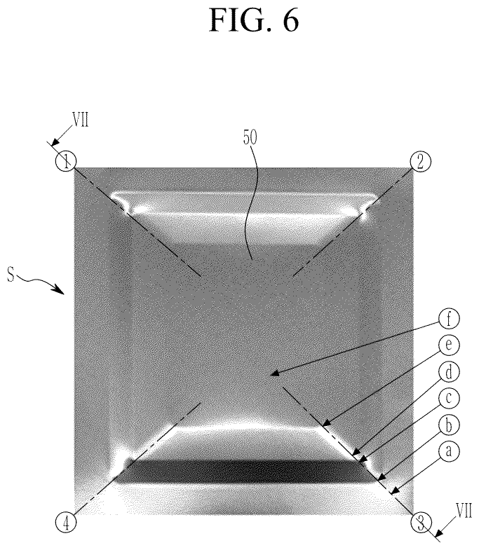

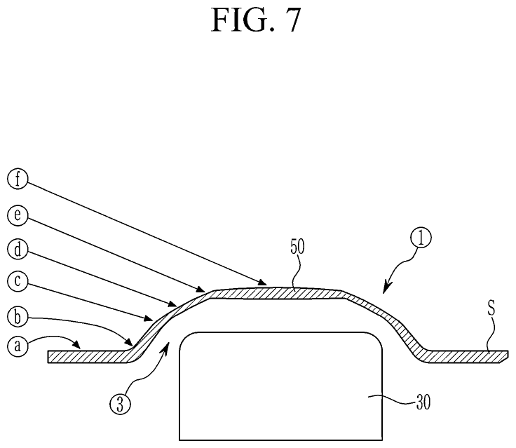

FIG. 6 is a planar image of a pouch reversely formed with the reverse punch having the length relationship of FIG. 5, and FIG. 7 is a cross-sectional view of a reverse forming state along line VII-VII of FIG. 6. A thickness (μm) shown in Table 1 may be obtained from the reverse forming portion 50 of FIGS. 6 and 7.

TABLE 1

| | | | First | Second | Third | |
|---|---|---|---|---|---|---|
| | Outer | Outer | reverse | reverse | reverse | |
| | flange | bending | stretching | stretching | stretching | Central |
| Measurement | region | region | region | region | region | region |
| position | \textcircled{a} | \textcircled{b} | \textcircled{c} | \textcircled{d} | \textcircled{e} | \textcircled{f} |
| First corner (\textcircled{1}) | 33.23 | 32.64 | 30.71 | 30.30 | 30.17 | 33.56 |
| Second corner (\textcircled{2}) | 32.79 | 31.09 | 30.36 | 31.77 | 31.34 | 33.05 |
| Third corner (\textcircled{3}) | 32.79 | 31.09 | 29.74 | 28.98 | 30.32 | 33.01 |
| Fourth corner (\textcircled{4}) | 33.15 | 31.20 | 30.56 | 31.52 | 31.32 | 33.09 |

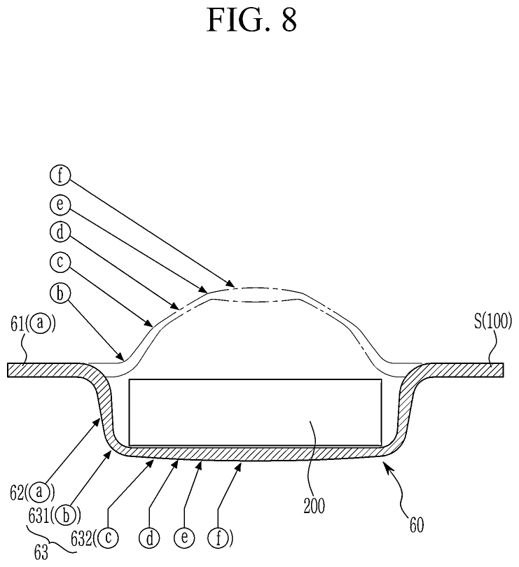

The reverse punch 30 forms the reverse forming portion 50 at portion to be a side wall corner portion 62 of the pouch 100 of FIG. 8 to be formed in the pouch substrate S, and a portion (a round portion 631 and a main bottom portion 632) corresponding to a bottom 63 connected to the side wall corner portion 62. In other words, when the reverse punch 30 forms the reverse forming portion 50, a portion of the pouch substrate S stretches through the first opening 11 to define a preliminary side wall corner portion and a preliminary button of the pouch 100 to be formed subsequently (FIG. 8).

The reverse forming portion 50 is formed at a portion other than a portion corresponding to the corner portion 62 and the bottom 63 connected to the corner portion 62, but a first corner \textcircled{1}, a second corner \textcircled{2}, a third corner \textcircled{3}, and a fourth corner \textcircled{4} forming the corner portion 62 of the pouch and the round portion 631 of the pouch connected to the corner portion 62 that are portions where it is substantially most difficult to secure a thickness, will be mainly described.

In the second corner \textcircled{2}, the reverse forming portion 50 includes an outer flange region \textcircled{a} provided at an outer periphery of the pouch substrate S, a central region \textcircled{f} minimally stretched from a center of the pouch substrate S, an outer bending region \textcircled{b} bent and stretched due to the reverse forming in the outer flange region \textcircled{a}, and a first reverse stretching region \textcircled{c}, a second reverse stretching region \textcircled{d}, and a third reverse stretching region \textcircled{e} sequentially stretched in a reverse direction between the outer bending region \textcircled{b} and the central region \textcircled{f}. Primary stretching of the first corner \textcircled{1}, the second corner \textcircled{2}, the third corner \textcircled{3}, and the fourth corner \textcircled{4} mainly occurs at the first reverse stretching region \textcircled{c}, the second reverse stretching region \textcircled{d}, and the third reverse stretching region \textcircled{e}. For example, as illustrated in FIG. 7, the first reverse stretching region \textcircled{c}, the second reverse stretching region \textcircled{d}, and the third reverse stretching region \textcircled{e} may be thinner than other portions of the reverse forming portion 50 due to the increased stretching in these regions.

The reverse punch 30 reversely forms the reverse direction depth D of the reverse forming portion 50 to 3.5 mm to 5.5 mm with respect to the outer flange region \textcircled{a} as a reference plane, and may stretch the first reverse stretching region \textcircled{c}, the second reverse stretching region \textcircled{d}, and the third reverse stretching region \textcircled{e} by about 4 μm to 5 μm. The reverse punch 30 maximally stretches the first reverse stretching region \textcircled{c}, the second reverse stretching region \textcircled{d}, and the third reverse stretching region \textcircled{e} at the reverse forming portion 50.

The reverse punch 30 forms the reverse forming portion 50. A thickness of a section between the outer bending region \textcircled{b} and the first reverse stretching region \textcircled{c} decreases at a first change rate. A thickness of a section between the first reverse stretching region \textcircled{c} and the second reverse stretching region \textcircled{d} decreases at a second change rate smaller than the first change rate. A thickness of a section between the second reverse stretching region \textcircled{d} and the third reverse stretching region \textcircled{e} generally increases inversely to the second change rate. A thickness of a section between the third reverse stretching region \textcircled{e} and the central region \textcircled{f} increases at a third change rate. The first reverse stretching region \textcircled{c}, the second reverse stretching region \textcircled{d}, and the third reverse stretching region \textcircled{e} by the primary stretching have generally similar thicknesses.

FIG. 8 is a cross-sectional view of a forming state after the reverse forming of FIG. 7. Referring to FIGS. 7 and 8, the punch 40 descends through the second opening 21 at a side of the second surface S2 of the pouch substrate S from an opposite side of the reverse punch 30 to secondarily stretch the pouch substrate S by forming the pouch substrate S. During the secondary stretching of the forming, the forming portion 60 is formed by supplementing a thickness of the side wall corner portion 62 of the pouch 100 to be formed and a thickness of the portion (the round portion 631 and the main bottom portion 632) corresponding to the bottom 63 of the pouch 100 connected to the side wall corner portion 62 by absorbing the primary stretching.

The forming portion 60 includes the side wall corner portion 62 connected to an outer flange 61 and the bottom 63 connected to the side wall corner portion 62, e.g., so the side wall corner portion 62 may be connected between the outer flange 61 and the bottom 63. The bottom 63 includes the round portion 631 (\textcircled{b}) connected to the side wall corner portion 62, and the main bottom portion 632 formed by absorbing the reverse forming portion 50 formed during the reverse forming.

In a diagonal direction of the main bottom portion 632, a forming length (L2) of the forming portion 60 formed during the forming is longer than a reverse forming length (L1) of the reverse forming portion 50 (L2>L1). The reverse forming length (L1) may be about 70% to 90% of the forming length (L2) (i.e., L1=(0.7 to 0.9)*L2), as discussed previously. The reverse forming length L1 is the ‘diagonal length’ of the reverse forming portion 50, and the forming length L2 is the ‘diagonal length’ of the forming portion 60.

The reverse forming portion 50 includes the outer flange region @, the outer bending region \textcircled{b}, the first reverse stretching region \textcircled{c}, the second reverse stretching region \textcircled{d}, the third reverse stretching region \textcircled{e}, and the central region \textcircled{f} sequentially formed from outer peripheries of the side wall corner portion 62 of the pouch 100 and the portion corresponding to the bottom 63 connected to the side wall corner portion 62 in the pouch substrate S to centers of the side wall corner portion 62 of the pouch 100 and the portion corresponding to the bottom 63 connected to the side wall corner portion 62.

The side wall corner portion 62 of the forming portion 60 is formed of a portion excluding the outer flange 61 at the outer flange region \textcircled{a}. The round portion 631(\textcircled{b}) of the pouch 100 is formed by stretching the outer bending region \textcircled{b} to be connected to the side wall corner portion 62. The main bottom portion 632 of the pouch 100 is formed by absorbing the first reverse stretching region \textcircled{c}, the second reverse stretching region \textcircled{d}, the third reverse stretching region \textcircled{e}, and the central region \textcircled{f}. In the bottom 63, a thickness of the main bottom portion 632 gradually increases as the main bottom portion 632 goes from the round portion 631 to a center of the bottom 63.

As an example, a height of the side wall corner portion 62 (\textcircled{a}) may be about 3.5 mm to 5.5 mm, and a thickness of the pouch 100 may be about 76 μm to 85 μm.

TABLE 2

| Forming | Comparative | Example |
|---|---|---|
| depth (mm) | Examples | Embodiments |
| 3.5 | 15.72 | 16.81 |
| 4.0 | 16.05 | 16.92 |
| 4.5 | 15.17 | 15.82 |

As shown in Table 2, when a thickness of the pouch 100 is 76 μm, a height of the side wall corner portion 62 (\textcircled{a}), i.e., a forming depth, is 3.5 mm to 4.5 mm, and a thickness of the round portion 631 (\textcircled{b}), in structures according to example embodiments, is 15.82 μm to 16.92 μm. It is seen in Table 2 that a thickness of the round portion 631 (\textcircled{b}), in structures according to example embodiments to which the reverse forming is applied, is secured to be thicker as compared with comparative examples, i.e., structures to which the reverse forming is not applied.

TABLE 3

| Forming | Comparative | Example |
|---|---|---|
| depth (mm) | examples | Embodiments |
| 4.0 | 17.39 | 18.01 |
| 4.5 | 16.04 | 17.54 |
| 5.0 | 15.34 | 16.13 |

As shown in Table 3, when a thickness of the pouch 100 is 85 μm, a height of the side wall corner portion 62 (\textcircled{a}), i.e., a forming depth, may be 4.0 mm to 5.0 mm, and a thickness of the round portion 631 (\textcircled{b}), in structures according to example embodiments, may be about 16 μm to 19 μm, e.g., 16.13 μm to 18.01 μm. It is seen in Table 3 that a thickness of the round portion 631 (\textcircled{b}), in structures according to example embodiments to which the reverse forming is applied, is secured to be thicker, as compared with the comparative examples (to which the reverse forming is not applied) and in which a thickness of the round portion 631 (\textcircled{b}) is 15 μm to 18 μm, e.g., 15.34 μm to 17.39 μm.

TABLE 4

| Forming portion | | Side wall | | Main | Main | Main | Main |
|---|---|---|---|---|---|---|---|
| (Forming portion | | corner | Round | bottom | bottom | bottom | bottom |
| and reverse | | portion | portion | portion | portion | portion | portion |
| forming | | (62 | (631 | (632 | (632 | (632 | (632 |
| portion) | | (\textcircled{a})) | (\textcircled{b})) | (\textcircled{c})) | (\textcircled{d})) | (\textcircled{e})) | (\textcircled{f})) |
| Comparative | 1 | 19.48 | 18.41 | 27.42 | 30.69 | 30.62 | 31.01 |
| Example | 2 | 19.89 | 18.04 | 28.43 | 31.23 | 31.34 | 30.05 |
| Example | 1 | 21.04 | 20.48 | 22.84 | 24.58 | 27.62 | 27.85 |
| Embodiments | 2 | 21.54 | 20.79 | 21.43 | 24.65 | 26.23 | 26.35 |

As shown in Table 4, when a thickness of the pouch 100 in Example Embodiments 1 and 2 is 85 μm, a thickness of the side wall corner portion 62 (\textcircled{a}), i.e., a forming depth, may be 21 μm to 22 μm, e.g., 21.04 μm to 21.54 μm, and a thickness of the round portion 631(\textcircled{b}) may be 20 μm to 21 μm, e.g., 20.48 μm to 20.79 μm. In contrast, in Comparative Examples 1 and 2, to which the reverse forming is not applied, a thickness of the side wall corner portion may be 19 μm to 20 μm, e.g., 19.48 μm to 19.89 μm, and a thickness of the round portion may be 18 μm to 19 μm, e.g., 18.04 μm to 18.41 μm.

Therefore, it may be seen that a thickness of the side wall corner portion 62 (\textcircled{a}) and a thickness of the round portion 631 (\textcircled{b}) are secured to be thicker in Embodiments 1 and 2 to (which the reverse forming is applied), as compared with Comparative Examples 1 and 2. It may be seen that a thickness of the main bottom portion 632 is secured to be thinner in Embodiments 1 and 2 compared with Comparative Examples 1 and 2.

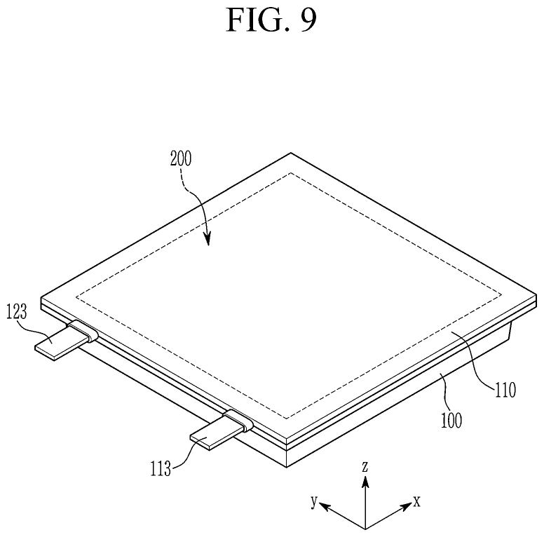

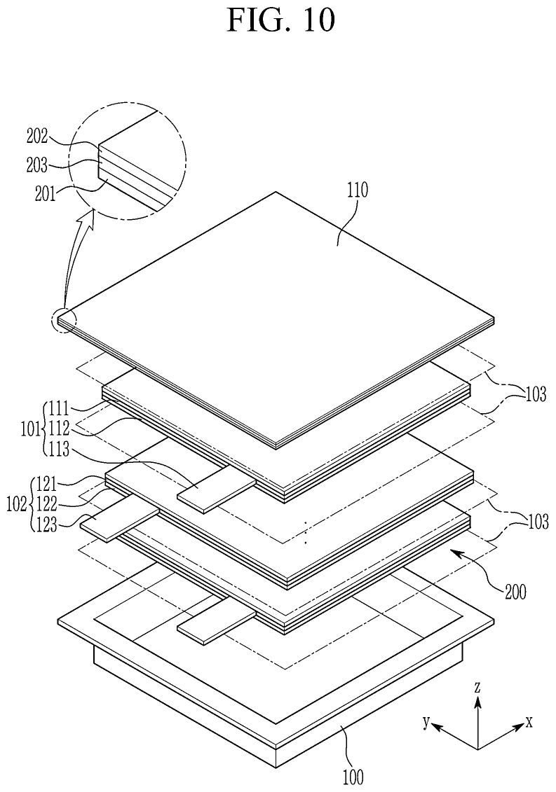

FIG. 9 is a perspective view of a rechargeable battery manufactured as a pouch through the reverse forming and the forming of FIG. 8, and FIG. 10 is an exploded perspective view of FIG. 9. Referring to FIGS. 9 and 10, the rechargeable battery according to an embodiment may include the pouch 100 and a stacking type of electrode assembly 200 included in the pouch 100.

The pouch 100 is manufactured through the reverse forming and the forming of the pouch substrate S, as shown in FIGS. 1 to 8. The pouch 100 includes the outer flange 61 disposed at an outer periphery thereof and the forming portion 60 formed by forming with respect to the reverse forming portion 50 (FIG. 8). For example, the pouch 100 may be integrally formed with a cover 110. In another example, the pouch 100 and the cover 110 may be separately formed.

The electrode assembly 200 may include a separator 103, and a first electrode plate 101 and a second electrode plate 102 formed of sheets at opposite, e.g., both, surfaces of the separator 103. That is, the electrode assembly 200 has a structure in which the first electrode plate 101 and the second electrode plate 102 are disposed at both surfaces of the separator 103 that is repeatedly disposed.

As an example, the first electrode plate 101 may be a positive electrode plate, and may include a positive electrode active material layer 112 at both surfaces of an electrode current collecting plate 111. The electrode current collecting plate 111 may include an electrode tab 113 with an uncoated portion protruding to one side. The electrode tab 113 may be directly drawn out of the pouch 100 or may be connected to a lead tab to be drawn out of the pouch 100.

The second electrode plate 102 may be a negative electrode plate, and may include a negative electrode active material layer 122 at opposite, e.g., both, surfaces of an electrode current collecting plate 121. The electrode current collecting plate 121 may include an electrode tab 123 with an uncoated portion protruding to one side. The electrode tab 123 may be directly drawn out of the pouch 100 or may be connected to a lead tab to be drawn out of the pouch 100.

In the rechargeable battery according to the embodiment, even when the stacking type of electrode assembly 200 is embedded in the pouch 100 formed by the reverse forming and the forming, a thickness of the side wall corner portion 62 and a thickness of the round portion 631 are stably secured.

For example, the pouch substrate S forming the pouch 100 and the cover 110 may be formed including a polymer sheet 201 forming an inner surface and acting as electrical insulation and thermal bonding, a nylon sheet 202 that forms an outer surface and acts as protection, and an aluminum sheet 203 providing mechanical strength. The aluminum sheet 203 may be a portion that contributes to securing thicknesses of the side wall corner portion 62 and the round portion 631 by the forming after the reverse forming of the pouch substrate S.

By way of summation and review, the pouch of the rechargeable battery accommodating the winding type electrode assembly may accommodate the electrode assembly even if a corner portion of the pouch is shaped (or formed) into a relatively large round shape. However, the pouch of the rechargeable battery accommodating the stacking type electrode assembly may require that a corner portion of the pouch be shaped into a smaller round shape than that of the pouch accommodating the winding type electrode assembly.

Implementation of the stacking type electrode assembly may be desirable due to an increase in a capacity of the rechargeable battery and a decrease in a thickness of a smartphone. However, when a pouch is formed for the stacking type electrode assembly, e.g., by deep drawing with a punch, securing a thickness at the corner portion of the pouch may be insufficient, thereby increasing a structural weakness of the pouch and reducing safety of the electrode assembly.

In contrast, the present disclosure provides a rechargeable battery that stably secures a thickness of a side wall corner portion of a pouch and a thickness of a bottom of the pouch connected to the side wall corner portion, even when a stack type of electrode assembly is implemented. That is, the pouch for the electrode assembly may be formed by deep drawing in which a substrate of the pouch is reversely formed with a reverse punch and then is formed with a punch (i.e., by a two-step process requiring a reverse punch prior to the punch).

In other words, as described above, an embodiment of the present disclosure may secure a sufficient thickness of a side wall corner portion of a pouch and a sufficient thickness of a (main) bottom of the pouch connected to the (round) side wall corner portion, even when a stack type of electrode assembly is implemented, since the pouch is formed (i.e., shaped) by deep drawing in which a substrate of the pouch is reversely formed with a reverse punch, followed by a punch.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A device for forming a pouch of a rechargeable battery, the device comprising:
a die including a first opening, the die being configured to support a first surface of a substrate of the pouch;
a stripper facing the die and including a second opening, the second opening being larger than the first opening, and the stripper being configured to hold a second surface of the substrate of the pouch;
a reverse punch in the first opening, the reverse punch being configured to ascend through the first opening toward the second opening while pushing the first surface of the substrate of the pouch into the second opening to perform a preliminary stretching; and
a punch in the second opening, the punch being configured to descend through the second opening toward the first opening while pushing the second surface of the substrate of the pouch into the first opening, the punch being configured to supplement a thickness of a side wall corner portion of the pouch and a thickness of a bottom connected to the side wall corner portion while performing a secondary stretching and absorbing the preliminary stretching.

2. The device as claimed in claim 1, wherein, in a diagonal cross-section of the substrate of the pouch corresponding to the side wall corner portion of the pouch and the bottom connected to the side wall corner portion, a length of the reverse punch is 70% to 90% of a length of the punch.

3. The device as claimed in claim 1, wherein a depth of the reverse punch in the second opening is 3.5 mm to 5.5 mm.

4. The device as claimed in claim 1, wherein the reverse punch is configured to form a reverse forming portion of the substrate of the pouch having a reverse direction depth within the second opening.

5. The device as claimed in claim 4, wherein the punch is configured to form a forming portion of the substrate of the pouch having a forward direction depth within the first opening while absorbing the reverse forming portion.

6. The device as claimed in claim 1, wherein:
the reverse punch is configured to form a reverse forming portion at the side wall corner portion of the pouch and a portion corresponding to the bottom connected to the side wall corner portion, and
the reverse forming portion includes an outer flange region provided at an outer periphery of the substrate of the pouch, a central region minimally stretched from a center of the substrate of the pouch, an outer bending region bent and stretched due to reverse forming of the substrate of the pouch in the outer flange region, and a first reverse stretching region, a second reverse stretching region, and a third reverse stretching region sequentially stretched in a reverse direction between the outer bending region and the central region.

7. The device as claimed in claim 6, wherein the reverse punch is configured to reversely form a reverse direction depth of the reverse forming portion to 3.5 mm to 5.5 mm with respect to the outer flange region as a reference plane, and to stretch the first reverse stretching region, the second reverse stretching region, and the third reverse stretching region by 4 μm to 5 μm.

8. The device as claimed in claim 6, wherein the reverse punch is configured to maximally stretch the first reverse stretching region, the second reverse stretching region, and the third reverse stretching region at the reverse forming portion.

9. The device as claimed in claim 8, wherein:
the reverse punch is configured to form the reverse forming portion, and
a thickness of a section between the outer bending region and the first reverse stretching region decreases at a first change rate, a thickness of a section between the first reverse stretching region and the second reverse stretching region decreases at a second change rate smaller than the first change rate, a thickness of a section between the second reverse stretching region and the third reverse stretching region increases inversely to the second change rate, and a thickness of a section between the third reverse stretching region and the central region increases at a third change rate.

10. A rechargeable battery, comprising:
a pouch including an outer flange and a forming portion, the outer flange being at an outer periphery of the pouch, and the forming portion being surrounded by the outer flange; and
a stacking type of an electrode assembly in the pouch,
wherein the forming portion includes:
a side wall corner portion integrally connected to the outer flange, and
a bottom connected to the side wall corner portion, the bottom including a round portion connected to the side wall corner portion and a main bottom formed by absorbing a reverse forming portion formed during reverse forming of the pouch.

11. The rechargeable battery as claimed in claim 10, wherein, in a diagonal direction of the main bottom, a forming length of the forming portion formed during the forming is longer than a reverse forming length of the reverse forming portion.

12. The rechargeable battery as claimed in claim 11, wherein the reverse forming length is 70% to 90% of the forming length.

13. The rechargeable battery as claimed in claim 11, wherein the reverse forming portion includes an outer flange region, an outer bending region, a first reverse stretching region, a second reverse stretching region, a third reverse stretching region, and a central region sequentially formed from outer peripheries of the side wall corner portion of the pouch and a portion corresponding to the bottom connected to the side wall corner portion in a substrate of the pouch to centers of the side wall corner portion of the pouch and the portion corresponding to the bottom connected to the side wall corner portion, and the side wall corner portion of the forming portion is formed of a portion excluding the outer flange at the outer flange region.

14. The rechargeable battery as claimed in claim 13, wherein the round portion is formed by stretching the outer bending region to be connected to the side wall corner portion, and the main bottom is formed by absorbing the first reverse stretching region, the second reverse stretching region, the third reverse stretching region, and the central region.

15. The rechargeable battery as claimed in claim 10, wherein a height of the side wall corner portion is 3.5 mm to 5.5 mm, and a thickness of the pouch is 76 μm to 85 μm.

16. The rechargeable battery as claimed in claim 10, wherein a height of the side wall corner portion is 3.5 mm to 4.5 mm, and when a thickness of the pouch is 76 μm, a thickness of the round portion is 15.82 μm to 16.92 μm.

17. The rechargeable battery as claimed in claim 10, wherein a height of the side wall corner portion is 4.0 mm to 5.0 mm, and when a thickness of the pouch is 85 μm, a thickness of the round portion is 16.13 μm to 18.01 μm.

18. The rechargeable battery as claimed in claim 10, wherein a thickness of the main bottom gradually increases as the main bottom extends from the round portion to a center of the bottom.

19. The rechargeable battery as claimed in claim 18, wherein when a thickness of the pouch is 85 μm and a thickness of the side wall corner portion is 21.04 μm to 21.54 μm, a thickness of the round portion is 20.48 μm to 20.79 μm.

20. The rechargeable battery as claimed in claim 19, wherein a thickness of the main bottom is 21.43 μm to 27.62 μm.
